(19) United States
(12) Patent Application Publication
(10) Pub. No.: US 2026/0312717 A1
(43) Pub. Date: Oct. 8, 2026

(54) SYSTEMS AND METHODS FOR ENHANCED BIT INTERLEAVING SCHEMES

(71) Applicant: QUALCOMM Incorporated, San Diego, CA (US)

(72) Inventors: Liangming Wu, Beijing (CN); Wei Liu, Beijing (CN); Kexin Xiao, Shanghai (CN); Jian Li, Shanghai (CN); Changlong Xu, Beijing (CN); Jing Jiang, San Diego, CA (US)

(21) Appl. No.: 19/483,123

(22) PCT Filed: Jul. 1, 2023
(86) PCT No.: PCT/CN2023/105458

§ 371 Date: Nov. 10, 2025

(51) Int. Cl. H04L 1/00; H04W 28/02

(52) U.S. Cl. CPC H04L 1/0009; H04L 1/0003; H04W 28/0236

(57) ABSTRACT

This disclosure provides systems, methods, and devices for wireless communication that support enhanced bit level ordering. In a first aspect, a method of wireless communication includes receiving a control channel transmission indicating a particular modulation coding scheme (MCS) for a transmission and performing bit-to-symbol mapping based on the particular MCS to generate the transmission. The method further includes transmitting the transmission in accordance with the bit-to-symbol mapping based on the particular MCS. Other aspects and features are also claimed and described.

### TECHNICAL FIELD

Aspects of the present disclosure relate generally to wireless communication systems, and more particularly, to bit level ordering and interleaving. Some features may enable and provide improved communications, including improved bit capacity and reduced bit errors for non-uniform constellations and fading channels.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication includes receiving a control channel transmission indicating a particular modulation coding scheme (MCS) for a transmission and performing bit-to-symbol mapping based on the particular MCS to generate the transmission. The method further includes transmitting the transmission in accordance with the bit-to-symbol mapping based on the particular MCS.

In an additional aspect of the disclosure, an apparatus configured for wireless communication is disclosed. The apparatus includes one or more processors, and one or more memories coupled to the one or more processors and storing. The processor-executable code, when executed by the one or more processors, are configured to cause the apparatus to receive a control channel transmission indicating a particular modulation coding scheme (MCS) for a transmission and to perform bit-to-symbol mapping based on the particular MCS to generate the transmission. The one or more processors are further configured to cause the apparatus to transmit the transmission in accordance with the bit-to-symbol mapping based on the particular MCS.

In an additional aspect of the disclosure, an apparatus configured for wireless communication is disclosed. The apparatus includes means for receiving a control channel transmission indicating a particular modulation coding scheme (MCS) for a transmission and means for performing bit-to-symbol mapping based on the particular MCS to generate the transmission. The apparatus further includes means for transmitting the transmission in accordance with the bit-to-symbol mapping based on the particular MCS.

In an additional aspect of the disclosure, a non-transitory computer-readable medium stores instructions that, when executed by a processor, cause the processor to perform operations including receiving a control channel transmission indicating a particular modulation coding scheme (MCS) for a transmission and performing bit-to-symbol mapping based on the particular MCS to generate the transmission. The operations further include transmitting the transmission in accordance with the bit-to-symbol mapping based on the particular MCS.

In an additional aspect of the disclosure, a method of wireless communication includes transmitting a control channel transmission indicating a particular modulation coding scheme (MCS) for a transmission. The method further includes receiving the transmission responsive to the control channel transmission and in accordance with a coded bit interleaving scheme determined based on the MCS.

In an additional aspect of the disclosure, an apparatus configured for wireless communication is disclosed. The apparatus includes one or more processors, and one or more memories coupled to the one or more processors and storing. The processor-executable code, when executed by the one or more processors, are configured to cause the apparatus to transmit a control channel transmission indicating a particular modulation coding scheme (MCS) for a transmission. The one or more processors are further configured to cause the apparatus to receive the transmission responsive to the control channel transmission and in accordance with a coded bit interleaving scheme determined based on the MCS.

In an additional aspect of the disclosure, an apparatus configured for wireless communication is disclosed. The apparatus includes means for transmitting a control channel transmission indicating a particular modulation coding scheme (MCS) for a transmission. The apparatus further includes means for receiving the transmission responsive to the control channel transmission and in accordance with a coded bit interleaving scheme determined based on the MCS.

In an additional aspect of the disclosure, a non-transitory computer-readable medium stores instructions that, when executed by a processor, cause the processor to perform operations including transmitting a control channel transmission indicating a particular modulation coding scheme (MCS) for a transmission. The operations further include receiving the transmission responsive to the control transmission and in accordance with a coded bit interleaving scheme determined based on the MCS.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a block diagram illustrating example blocks executed by an encoder configured according to an aspect of the present disclosure.

FIG. 3B is a block diagram illustrating example blocks executed by another encoder configured according to an aspect of the present disclosure.

FIG. 3C is a diagram illustrating an example of a geometric shaped constellation according to an aspect of the present disclosure.

FIG. 3D is a diagram illustrating an example of a probabilistic shaped constellation according to an aspect of the present disclosure.

FIG. 4 is a block diagram illustrating an example wireless communication system that supports enhanced bit interleaving schemes according to one or more aspects.

FIG. 5 is a diagram illustrating an example of a table that supports enhanced bit interleaving schemes according to one or more aspects.

FIG. 6 is a diagram illustrating an example of a table that supports enhanced bit interleaving schemes according to one or more aspects.

FIG. 7 is a diagram illustrating an example of a table that supports enhanced bit interleaving schemes according to one or more aspects.

FIG. 8 is a flow diagram illustrating an example process that supports enhanced bit interleaving schemes according to one or more aspects.

FIG. 9 is a flow diagram illustrating an example process that supports enhanced bit interleaving schemes according to one or more aspects.

FIG. 10 is a block diagram of an example UE that supports enhanced bit interleaving schemes according to one or more aspects.

FIG. 11 is a block diagram of an example base station that supports enhanced bit interleaving schemes according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support enhanced bit level ordering. Enhanced bit level ordering, such as coded bit ordering, may improve transmission reliability and throughput by enabling data information, data bits, to be carried in higher reliability and/or higher throughput bit positions. The aspects described herein present enhanced bit level ordering and interleaving schemes and present schemes for indicating and/or determining the enhanced and different bit order schemes.

Particular implementations of the subject matter described in this disclosure may be implemented to realize one or more of the following potential advantages or benefits. In some aspects, the present disclosure provides techniques for coded bit interleaving and flexible coded bit ordering, as compared to conventional sequential coded bit ordering. Coded bit interleaving may improve throughput and reliability, including improving throughput and reliability when using non-uniform constellations for bit mapping (e.g., geometric constellations). Additionally, the present disclosure provides techniques for reducing the effects of fading channels and increasing throughput and reliability for different channel conditions (e.g., different SNR, different MCS, different numbers of bits, different frequency resources, etc.).

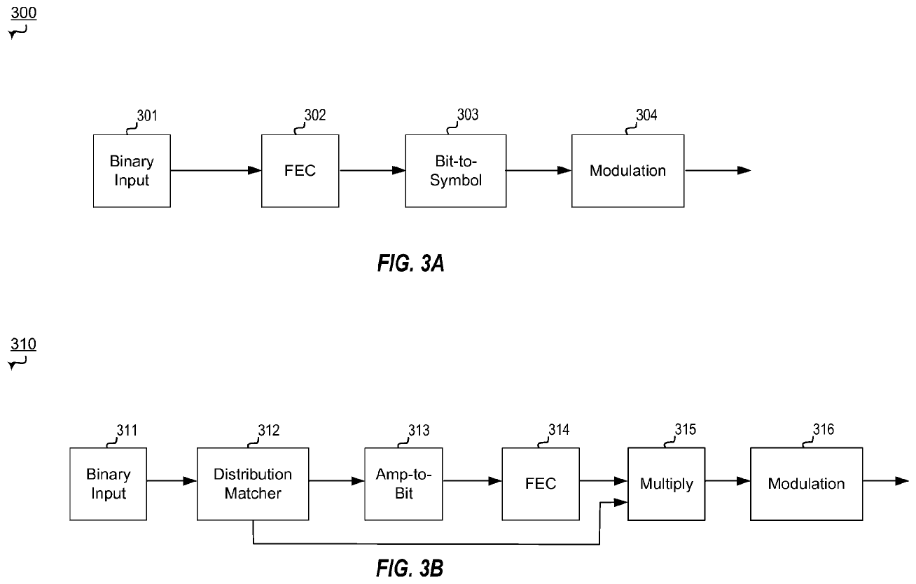

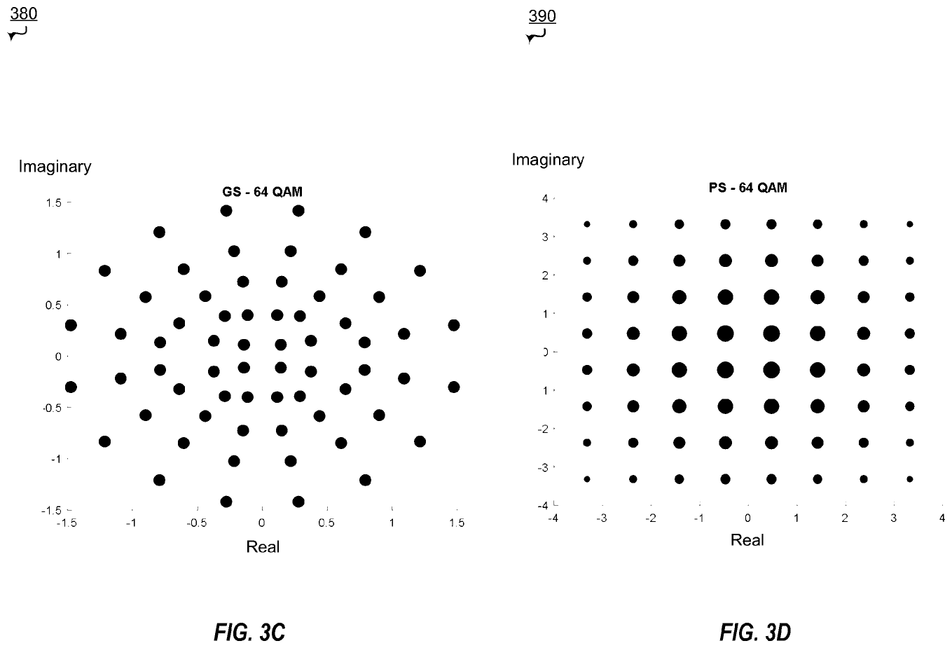

Non-uniform constellations, such as geometric constellations or constellations with geometric shaping, have lower gain than constellations with probabilistic shaping. However, such non-uniform constellations are robust and more resistant to phase noise. Additionally, such non-uniform constellations can leverage existing coding and modulation flow. For example, an extra distribution matcher or distribution matching step, as used in probabilistic shaped constellations, is not needed, as described further with reference to FIGS. 3A and 3B.

Non-uniform constellations have different bit level capacities than probabilistic shaped constellations. Probabilistic shaped constellations have a bit capacity that follows bit order. That is, lower order bits (earlier bits in the sequence) have higher bit capacities and higher reliability. For non-uniform constellations this is not the case. To illustrate, with a bit order of 6 (i.e., a six-bit length sequence) a particular later or higher order bit can have a higher bit level capacity and reliability than an earlier or lower order bit. As an illustrative example, bit 5 may have a higher capacity and/or reliability than bit 4 under some operating conditions, such as when certain modulation and coding schemes (MCSs) are used and/or at certain frequencies.

Thus, conventional techniques for ordering of bits, such as systematic bit priority mapping (SBPM), do not match or maximize the bit level capacity when non-uniform constellations are used. Additionally, or alternatively, when operating in different or fading channel conditions, different frequency resources (e.g., subbands) may have different signal-to-noise ratios (SNRs). These different SNRs may lead to differences in bit levels, and enhanced interleaving schemes can be used to account for fading channel conditions.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ~1 M nodes/km²), ultra-low complexity (e.g., ~10 s of bits/sec), ultra-low energy (e.g., ~10+ years of battery life), and deep coverage with the capability to reach challenging locations; (2) including mission-critical control with strong security to safeguard sensitive personal, financial, or classified information, ultra-high reliability (e.g., ~99.9999% reliability), ultra-low latency (e.g., ~1 millisecond (ms)), and users with wide ranges of mobility or lack thereof; and (3) with enhanced mobile broadband including extreme high capacity (e.g., ~10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

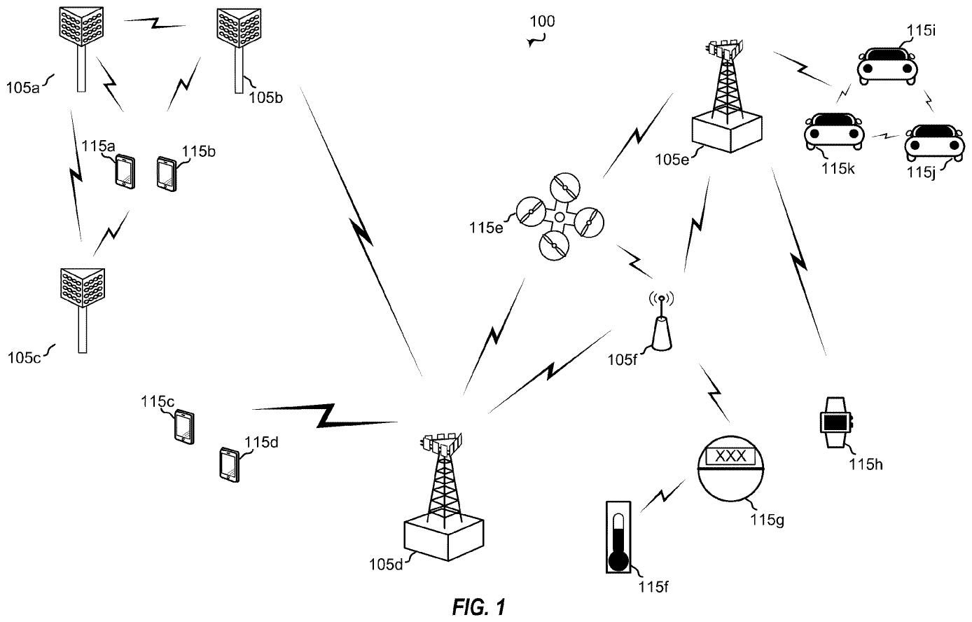

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

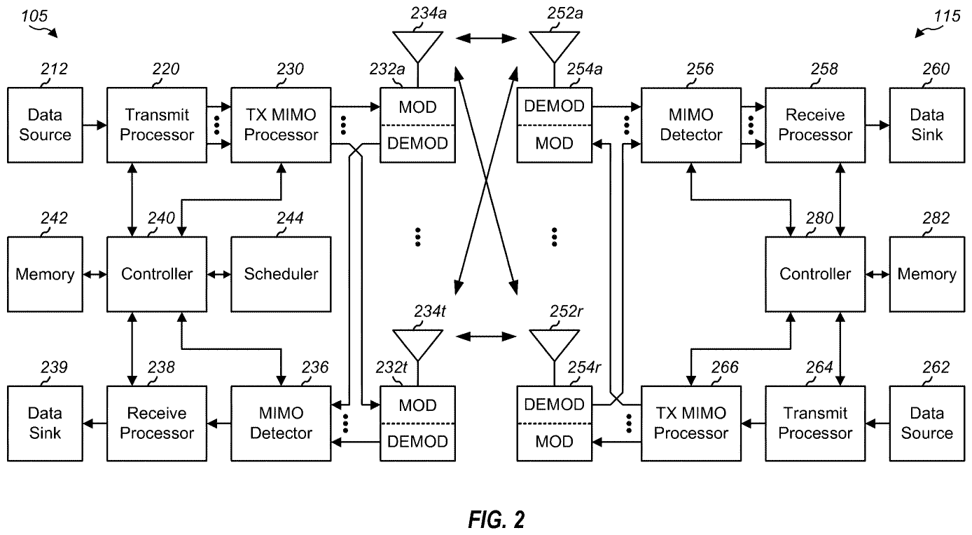

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 1-11, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

FIGS. 3A and 3B illustrate examples of encoding flows using the constellations of FIGS. 3C and 3D for bit-to-symbol mapping. Referring to FIG. 3A, FIG. 3A illustrates an example of an encoding flow 300 for an encoder in accordance with aspects of the present disclosure. In some examples, the encoding flow 300 may be performed by an encoder of wireless communication system 100 or 400. For example, the encoder may be included in UE 115 and/or network entity (e.g., base station 105).

The encoder flow 300 includes receiving a binary input at 301, performing forward error correction (FEC) at 302, performing bit-to-symbol mapping at 303, and symbol modulation at 304.

At 301, a binary input is received, such as a sequence of zeros and ones. The sequence of zeros and ones may correspond to a sequence of coded bits of a code block for a transmission, such as c0-c8. The binary input may include or correspond to raw input bits, e.g., a0-a8, or may include or correspond to channel coded bits, c0-c8.

At 302, FEC is performed on the binary input to generate a corrected binary input. For example, parity and/or CRC bits are added or inserted into the binary input. These bits may include or correspond to non-data bits and may be appended to the end of the sequence (e.g., concatenated) or added/interleaved into the sequence. The parity bits may be added prior to the CRC bits and prior to encoding, and the CRC bits may be appended to the sequence after encoding (e.g., an encoded sequence) and prior to FEC. FEC may include or correspond to channel coding.

At 303, bit-to-symbol mapping is performed. For example, one or more bits of the sequence are mapped to symbols of a constellation. To illustrate, multiple adjacent bits are mapped to symbols of the geometric shaped constellation 380 of FIG. 3C. With reference to the geometric shaped constellation 380 of FIG. 3C, eight adjacent bits may be mapped to the corresponding symbol based on the values of the eight adjacent bits of the corrected bit sequence.

At 304, symbol modulation is performed. For example, a transmitter may generate or modulate a signal based on the symbol to generate or transmit a transmission.

Referring to FIG. 3B, FIG. 3B illustrates an example of another encoding flow 310 for an encoder in accordance with aspects of the present disclosure. In some examples, the encoding flow 310 may be performed by an encoder of wireless communication system 100 or 400. For example, the encoder may be included in UE 115 and/or network entity (e.g., base station 105).

The encoder flow 310 includes receiving a binary input at 311, performing distribution matching at 312, performing amplitude to bit conversion at 313, performing FEC at 314, performing mapping at 315 and symbol modulation at 316.

At 311, a binary input is received, such as a sequence of zeros and ones. The sequence of zeros and ones may correspond to a sequence of coded bits of a code block for a transmission, such as c0-c8. The binary input may include or correspond to raw input bits, e.g., a0-a8, or may include or correspond to channel coded bits, c0-c8.

At 312, distribution matching is performed. For example, amplitude shaping may be performed to encode the binary input data sequence into a sequence of symbols or codewords with a desired target probability distribution.

At 313, amplitude to bit conversion is performed on the sequence of symbols or code words to determine a bit sequence, such as a coded bit sequence. The coded bit sequence may include or correspond to raw input bits, e.g., a0-a8, or may include or correspond to channel coded bits, c0-c8.

At 314, FEC is performed on the coded bit sequence to generate a corrected bit sequence. For example, parity and/or CRC bits are added or inserted into the coded bit sequence. These bits may include or correspond to non-data bits and may be appended to the end of the sequence (e.g., concatenated) or added/interleaved into the sequence.

At 315, bit-to-symbol mapping is performed. For example, one or more bits of the sequence are mapped to symbols of a constellation. To illustrate, multiple adjacent bits are mapped to symbols of the uniform shaped constellation 390 of FIG. 3D. With reference to the uniform shaped constellation 390 of FIG. 3D, eight adjacent bits may be mapped to the corresponding symbol based on the values of the eight adjacent bits of the corrected bit sequence.

At 316, symbol modulation is performed. For example, a transmitter may generate or modulate a signal based on the symbol to generate or transmit a transmission. As compared to the encoding flow 300 of FIG. 3A, the encoding flow 310 has extra steps for distribution matching. The bits and corresponding symbols of transmissions encoded by the encoding flow 310 (and mapped using the uniform shaped constellation 390 of FIG. 3D) may have uniform bit level capacity or a bit level capacity that decreases with bit order. That is earlier position bits always have higher capacity than later position bits.

However, the bits and corresponding symbols of transmissions encoded by the encoding flow 300 (and mapped using the geometric shaped constellation 380 of FIG. 3C) do not have a uniform bit level capacity or a bit level capacity that always decreases with bit order. Thus, current NR-LDPC and SBPM interleaving techniques which always map data bits to earlier bit positions, may map data bits encoded using non-uniform shaped constellations (e.g., the geometric shaped constellation 380 of FIG. 3C) to less reliable positions and to lower capacities. The aspects described herein provide systems and methods for enhanced bit ordering or coded bit interleaving to more efficiently map the data bits to higher reliability and capacity bits. The aspects described herein provide implementations for modifying bit interleaving schemes based on MCS, frequency resources, bit capacity, or a combination thereof.

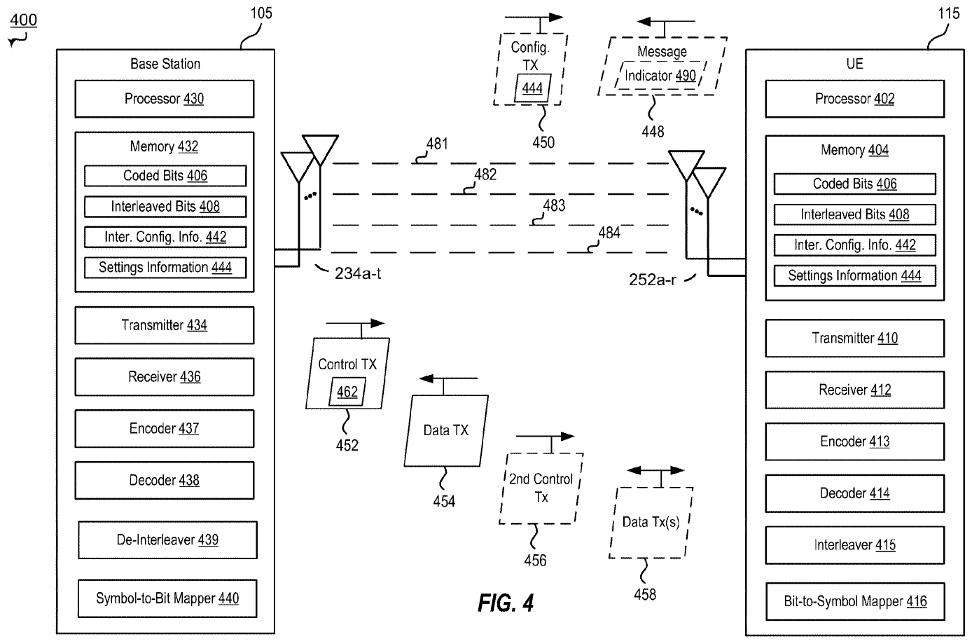

FIG. 4 illustrates an example of a wireless communications system 400 that supports enhanced bit level ordering in accordance with aspects of the present disclosure. In some examples, wireless communications system 400 may implement aspects of wireless communication system 100. For example, wireless communications system 400 may include a network, such as one or more network entities, and one or more UEs, such as UE 115 and optionally a second UE. As illustrated in the example of FIG. 4, the network entity includes a corresponds to a base station, such as base station 105. Alternatively, the network entity may include or correspond to a different network device (e.g., not a base station). Enhanced bit level ordering may reduce failures, such as beam failure, radio link failures, connection establishment failures, etc. and enable improved throughput. The improved throughput and reliability may occur even on different operating conditions or fading channels and/or when using non-uniform constellations (e.g., geometric constellations). These improvements may reduce latency and increase throughput by improving connection quality and reducing interference and failures. Accordingly, network and device performance can be increased.

Base station 105 and UE 115 may be configured to communicate via one or more portions of the electromagnetic spectrum. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “mmWave” band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

It is noted that SCS may be equal to 15, 30, 60, or 120 kHz for some data channels. Base station 105 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, or a Bandwidth Part (BWP) ID. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management or BWP switching functionality. In some implementations, two or more CCs are quasi co-located, such that the CCs have the same beam and/or same symbol.

In some implementations, control information may be communicated via base station 105 and UE 115. For example, the control information may be communicated suing MAC-CE transmissions, RRC transmissions, DCI (downlink control information) transmissions, UCI (uplink control information) transmissions, SCI (sidelink control information) transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, interleaver 415, bit-to-symbol mapper 416, and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store coded bits 406, interleaved bits 408, interleaving configuration information 442, settings information 444, or a combination thereof, as further described herein.

The coded bits 406 includes or corresponds an input sequence of coded bits which has been encoded (e.g., channel encoding) for prior to ordering for bit-to-symbol mapping or data associated with an input sequence of coded bits. For example, the coded bits 406 may include or correspond to an encoded bit sequence of a code block, such as d0-d6. The coded bits 406 may be stored as a sequence of bits (e.g., zeros and ones) and correspond to one or more transmissions.

The interleaved bits 408 (interleaved coded bits) includes or corresponds a sequence of coded bits which has been ordered (e.g., reordered) for bit-to-symbol mapping or data associated with a sequence of interleaved coded bits. For example, the interleaved bits 408 may include or correspond to a rearranged encoded bit sequence of a code block, such as d0, d1, d2, d4, d3, d5, d6. The interleaved bits 408 may be stored as a sequence of bits (e.g., zeros and ones) and correspond to one or more transmissions.

The interleaving configuration information 442 (e.g., coded bit interleaving configuration information) includes or corresponds to data indicating or corresponding to coded bit interleaving configurations. For example, the interleaving configuration information 442 may include or correspond to coded bit interleaving scheme information, coded bit order information, or a combination thereof. Additionally, or alternatively, the interleaving configuration information 442 may include or correspond to ifnormation for determining a particular interleaving configuration or scheme (e.g., an order of bits or way to interleave bits). A transmission may include or be generated based on the interleaving configuration information 442. To illustrate, a transmission may be generated by modulating symbols corresponding to an interleaved coded bit sequence (e.g., interleaved bits 408), where the interleaved coded bit sequence was generated (e.g., interleaved or bit-to-symbol mapped) from a coded bit sequence (e.g., coded bits 406) based on an interleaving scheme or interleaving order determined based on the interleaving configuration information 442 and the MCS. The interleaving configuration information scheme may be further determined based on frequency resource information, bit information, or a combination thereof, as further described herein.

The settings information 444 includes or corresponds to data associated with enhanced coded bit interleaving operations. The settings information 444 may include one or more types of enhanced coded bit interleaving operation modes and/or thresholds or conditions for switching between enhanced coded bit interleaving modes and/or configurations thereof. For example, the settings information 444 may have data indicating different thresholds and/or conditions for different enhanced coded bit interleaving modes, such as how to determine a coded bit interleaving scheme, what parameters to use to determine a coded bit interleaving, how to implement a coded bit interleaving scheme, when to change between coded bit interleaving schemes, etc., or a combination thereof.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410 or receiver, 412 may include or correspond to one or more components of UE 115 described with reference to FIG. 2.

Encoder 413 and decoder 414 may be configured to encode and decode data for transmission. Interleaver 415 may be configured to perform interleaving or bit level ordering operations, such as coded bit interleaving operations. For example, the interleaver 415 may be configured to determine and/or select a particular interleaving scheme from a plurality of interleaving schemes. To illustrate, the interleaver 415 may be configured to determine a particular interleaving scheme (e.g., order of coded bits and/or how to reorder a coded bit sequence) based on the 442 and a particular indicated MCS. The interleaver 415 may be configured to determine the particular interleaving scheme based on other parameters in other implementations, as described further herein, such as frequency information, bit capacity information, bit error information, etc., or a combination thereof. As another example, the interleaver 415 may be configured to perform interleaving operations. To illustrate, the interleaver 415 may reorder the coded bits 406 to generate the interleaved bits 408. That is the interleaver 415 may change a bit position of one or more bits of the coded bits 406 to reorder the coded bits into the interleaved bits 408.

Bit-to-symbol mapper 416 may be configured to bit-to-symbol mapping operations. For example, the bit-to-symbol mapper 416 may be configured to determine symbols for modulation based on a constellation and the interleaved bits 408. To illustrate, the bit-to-symbol mapper 416 may determine a symbol to be transmitted based on one or more bits of the interleaved bits 408. In some implementations, the bit-to-symbol mapper 416 uses a non-uniform constellation, such as constellation where the symbols are not evenly spaced from adjacent symbols. One example of such a non-uniform constellation is a geometric constellation.

Optionally, the system may include one or more second UEs. The second UEs may include one or more elements similar to UE 115. In some implementations, the UE 115 and the second UE are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc.

Base station 105 includes processor 430, memory 432, transmitter 434, receiver 436, encoder 437, decoder 438, de-interleaver 439, symbol-to-bit mapper 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store coded bits 406, interleaved bits 408, interleaving configuration information 442, settings information 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, UEs and/or base station 105 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434 or receiver, 436 may include or correspond to one or more components of UE 115 described with reference to FIG. 2.

Encoder 437, and decoder 438 may include the same functionality as described with reference to encoder 413 and decoder 414, respectively. De-interleaver 439 may include similar functionality (e.g., opposite or mirrored functionality) as described with reference to interleaver 415. For example, de-interleaver 439 may be configured to perform de-interleaving operations or ordering operations to rearrange the interleaved bits 408 back to the coded bits 406. Symbol-to-bit mapper 440 may include similar functionality (e.g., opposite or mirrored functionality) as described with reference to bit-to-symbol mapper 416. For example, symbol-to-bit mapper 440 may be configured to perform symbol de-mapping operations or symbol conversion operations to determine bits of the interleaved bits 408 based on symbols of received transmissions. In some implementations, the base station 105 may further include an interleaver 415 and a bit-to-symbol mapper 416. Additionally, or alternatively, the UE 115 may further include a de-interleaver 439 and a symbol-to-bit mapper 440.

During operation of wireless communications system 400, the network (e.g., base station 105) may determine that UE 115 has enhanced bit level ordering capability. For example, UE 115 may transmit a message 448 that includes an enhanced bit level ordering indicator 490 (e.g., an enhanced sidelink information reporting capability indicator). Indicator 490 may indicate enhanced bit level ordering capability for one or more communication modes, such as downlink, uplink, sidelink, relay link, etc., for a particular type of modulation, such as for when non-uniform constellations are used, or for a particular condition or conditions, such as for a fading channel. In some implementations, a network entity (e.g., a base station 105) sends control information to indicate to UE 115 that enhanced bit level ordering operations and/or a particular type of enhanced bit level ordering operation is to be used. For example, in some implementations, configuration transmission 450 is transmitted to the UE 115. The configuration transmission 450 may include or indicate to use enhanced bit level ordering operations or to adjust or implement a setting of a particular type of enhanced bit level ordering operation. For example, the configuration transmission 450 may include interleaving configuration information 442, as indicated in the example of FIG. 4, settings information 444, or any combination thereof.

During operation, devices of wireless communications system 400 perform bit level ordering operations. For example, the network and UEs may exchange transmissions via uplink, downlink, and/or sidelink communications over the communication links and engage in enhanced coded bit interleaving operations as illustrated in the example of FIG. 4. This enhanced bit level ordering enables devices to better utilize the capacity of bits and prioritize data bits (as opposed to CRC or parity bits) to higher reliability and throughput bit positions. The increased utilization of bit level capacity increases reliability and throughput, which then further reduces latency and improves user experience. The enhanced bit level ordering may be achieved by utilizing SNR, such as through MCS indication, to determine more efficient bit level ordering and to interleave coded bits. Additionally, other information, such as frequency resources and specific bit level capacity and/or error information may also be used to determine more efficient bit level ordering and to interleave coded bits.

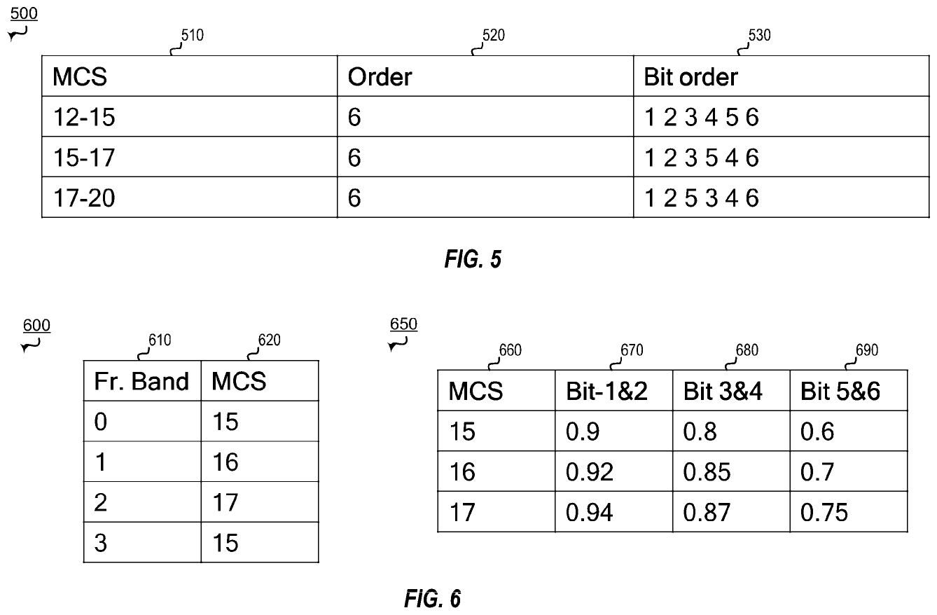

In the example of FIG. 4, the devices of the network may communicate with each other using different and/or more efficient bit level ordering. For example, the base station 105 may transmit a control transmission 452 to the UE 115. The control transmission 452 may signal and/or schedule a particular transmission, such as a future uplink or downlink transmission and indicate corresponding MCS information 462, such as a particular MCS to use or that will be used for the transmission. In the example of FIG. 4, the control transmission schedules an uplink transmission, such as a data transmission 454, and provides a particular MCS for the uplink transmission, such as a first MCS for the data transmission 454. The control transmission 452 may include or correspond to broadcast message, a RRC message, a DCI transmission, or a PDCCH. Examples of information included in such control transmissions are described further with reference to FIGS. 5-7B. The MCS information 462 may include or correspond to an MCS indication which directly or indirectly identifies the MCS for one or more upcoming transmissions.

The UE 115 receives the control transmission 452 and determines the data transmission 454 and the corresponding MCS based on the control transmission 452. For example, when the control transmission 452 is a DCI, the DCI indicates or assigns transmission resources (e.g., time and frequency resources) to the UE 115 and indicates the particular MCS to use.

The UE 115 generates and transmits the data transmission 454 to the base station 105 based on the control transmission 452. For example, the UE 115 determines an interleaving scheme (e.g., a coded bit interleaving scheme) to use based on the particular MCS indicated in the control transmission 452 and based on the interleaving configuration information 442. To illustrate, the UE 115 selects a particular interleaving scheme (e.g., an order of bits) from a plurality of interleaving schemes (e.g., a plurality of orders of bits) based on the MCS. The UE 115 then uses the determined interleaving scheme to reorder the coded bits 406 corresponding to the data transmission 454 to generate the interleaved bit 408. The UE 115 then determines the symbols corresponding to the interleaved bits 408. For example, the UE 115 determines symbols for the interleaved bit 408 using a non-uniform constellation and the MCS. To illustrate, the UE 115 maps one or more bits for the interleaved bit 408 to a particular symbol of the constellation. The UE 115 then transmits the symbols to transmit the transmission. Optionally, the UE 115 may utilize other parameters in addition to or in the alternative of MCS, such as SNR, frequency resources, bit capacity and/or error information, or a combination thereof, as further described with reference to FIGS. 5-7B.

The base station 105 receives the data transmission 454 and processes the data transmission in accordance with the indicated MCS in the control transmission 452. For example, the base station 105, such as the symbol-to-bit mapper 440 thereof, determines one or more bits of the interleaved bits 408 based on the received symbols. Then the base station 105, such as the de-interleaver 439 thereof, reorders (de-interleaves) the bits of the interleaved bits 408 to generate the coded bits 406. The base station may then further process (e.g., channel decoding) the coded bits 406 to determine the data/information of the data transmission 454.

Additionally, in some implementations, the devices of the network may send additional transmission with different bit level orderings. For example, the base station 105 and the UE 115 may engage in another transmission with a different bit level ordering or interleaving scheme, as shown by optional transmissions 456 and 458. To illustrate, the base station 105 may transmit a second control transmission 456 to the UE 115. The second control transmission 456 may signal and/or schedule a second particular transmission, such as a future uplink or downlink transmission and indicate corresponding MCS information, such as a second particular MCS to use or that will be used for the second transmission. In the example of FIG. 4, the control transmission may schedule an uplink transmission or a downlink transmission, such as a data transmission 458, and provides a second particular MCS for the uplink transmission, such as a second MCS for the second data transmission 458. The second control transmission 456 may include or correspond to broadcast message, a RRC message, a DCI transmission, or a PDCCH.

The UE 115 receives the second control transmission 456 and determines the second data transmission 458 and the corresponding second MCS based on second control transmission 456. For example, when second control transmission 456 is a DCI (e.g., second DCI), the DCI indicates or assigns transmission resources (e.g., time and frequency resources) to the UE 115 and indicates the second particular MCS to use.

In some implementations, the UE 115 generates and transmits the second data transmission 458 to the base station 105 based on the second control transmission 456, similar to as described above for the data transmission 454. For example, the UE 115 determines a second interleaving scheme to use based on the second particular MCS indicated in the second control transmission 456 and based on the interleaving configuration information 442. The second interleaving scheme may be different than the first interleaving scheme. To illustrate, the first interleaving scheme may be 124356 and the second interleaving scheme may be 123456 or 124346, as illustrative, non-limiting examples. Thus, while the transmissions may have the same bit order, i.e., the same number or length of bits, the ordering or positions of the coded bits themselves differs. Alternatively, the base station 105 may transmit the second data transmission 458 and may perform interleaving and bit-to-symbol mapping as described with reference to the UE 115, and the UE 115 may receive the second data transmission 458 and may perform symbol-to-bit mapping and de-interleaving as described with reference to the base station 105 for downlink transmission operations.

Although uplink and downlink examples are illustrated in the example of FIG. 4, in other implementations devices of the network may utilize enhanced bit level ordering in other modes, such as in sidelink modes/for sidelink communications, e.g., direct device-to-device communications. To illustrate a sidelink control channel transmission or SCI may indicate a MCS and two UEs may perform the operations described herein to send sidelink data transmissions with different bit level orderings.

Accordingly, the network (e.g., the base station 105, the UE 115, and optionally other devices) may be able perform bit level ordering/interleaving to more efficiently and effectively utilize bit capacity. More effective usage of bit level capacity, reduces failures and increases throughput and reduces latency, which leads to better network operations. Accordingly, the network performance and experience may be increased due to the increases in speed and reductions in failure.

Referring to FIG. 5, FIG. 5 is a diagram illustrating a table 500 that supports enhanced bit level ordering according to one or more aspects. The example of FIG. 5 corresponds to an example of a table for enhanced bit level ordering operations, and specifically for determining an order of bits based on MCS. In the example of FIG. 5, the table 500 includes three columns, a first column, MCS column 510, a second column, bit order column 520, and a third column, order of bits column 530. The table 500 indicates a particular order of bits, i.e., a sequence of bit positions in the third column, order of bits column 530, for each combination of MCS and order (i.e., each combination of the first and second columns).

As illustrated in the example of FIG. 5, one or more MCSs (e.g., MCS values) may be mapped to the same order of bits. To illustrate, each of MCS 12-15 is mapped to the same order of bits of 123456 for a bit order (i.e., bit sequence length) of 6. As described above, the aspects herein modify the order of bits for different parameters. For example, when the MCS value is 15-17 or 17-20, the order of bits changes from 123456 for the MCS of 12-15 to 123546 or to 125346. Thus, devices of the network can modify the order of bits per transmission based on the MCS. As described above, the MCS is often determined based on the SNR (e.g., SNR values may have associated MCS values) of the channel, and thus modifying the order of bits based on the MCS enables devices of the network to modify the order of bits based on the SNR or to modify the order of bits to account for the SNR of the channel and the different bit capacities and reliabilities.

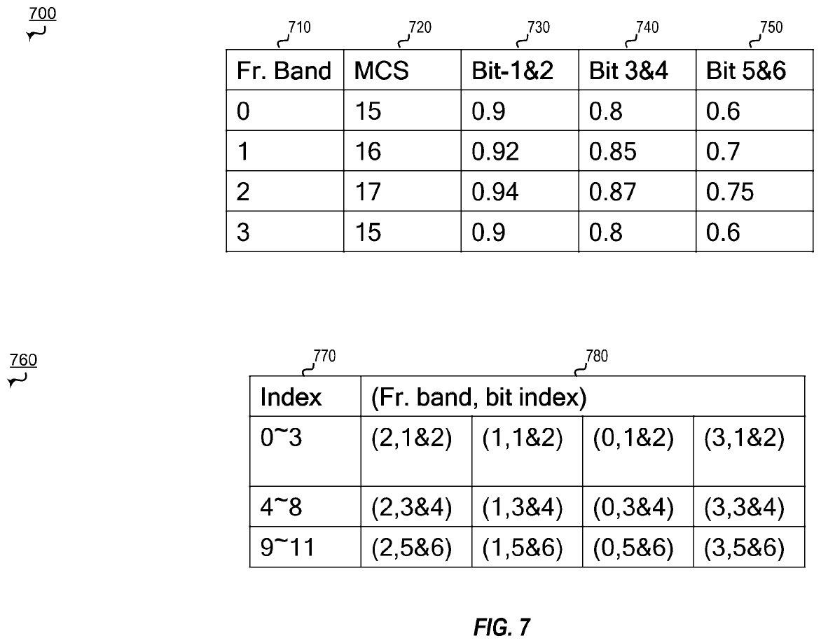

Alternatively, the order of bits can be modified based on the SNR directly. In some such implementations, the devices of the network may further determine the order of bits on MCS, and in other such implementations, the devices of the network may determine the order of bits independent of the MCS. As an illustrative example, the devices of the network may exchange or signal SNR information, and use the SNR information to determine the order of bits. To illustrate, in such implementations, the table 500 may include another column for SNR or may replace the first column (MCS column 510) with an SNR column. In addition, the order of bits can be modified based on other parameters, such as described with reference to FIGS. 6 and 7.

Table 500 may be determined by the network and transmitted to UEs of the network. For example, table 500 may be set or configured by RRC or predetermined by a network or region. To illustrate information for generating table 500 may be sent in the configuration transmission 450 of FIG. 4 and/or the control transmission 452 of FIG. 4. A device of the network, such as UE 115 or base station 105, may utilize the table 500 to determine an order of bits for a given combination of bit order and MCS.

Referring to FIG. 6, FIG. 6 is a diagram illustrating a table 600 and a table 650 that support enhanced bit level ordering according to one or more aspects. The example of FIG. 6 corresponds to an example of tables for enhanced bit level ordering operations, and specifically for determining an order of bits based on MCS and bit information. In the example of FIG. 6, the table 600 includes two columns, a first column, a frequency band column 610, and a second column, a MCS column 620. The table 600 indicates a particular MCS to be used with each frequency band or indicates a particular active MCS for each scheduled frequency band. Although table 600 indicates a particular example of MCS per frequency band in the example of FIG. 6, in other examples the table 600 may indicate MCS values for frequency ranges, frequency bands, subbands, layers, slots, etc., or a combination thereof.

In the example of FIG. 6, the table 650 includes four columns, including a first column, a MCS column 660, a second column, a first and second bit column 670, a third column, a third and fourth bit column 680, and a fourth column, a fifth and sixth bit column 690. The table 650 indicates a particular bit reliability of each bit (or group of bits) of a given bit order (6-bit length sequence) for each MCS. To illustrate, for an MCS of 15, the first and second bit positions have a reliability value of 0.9 (e.g., 90 percent), the third and fourth bit positions have a reliability value of 0.8 (e.g., 80 percent), and the fifth and sixth bit positions have a reliability value of 0.6 (e.g., 60 percent). Although table 650 indicates a particular example of bit reliability per MCS in the example of FIG. 6, in other examples the table 650 may indicate bit capacity or error rates per MCS values. Additionally, or alternatively, although table 650 indicates a particular example of bit reliability per MCS in the example of FIG. 6, in other examples the table 650 may indicate bit reliability per MCS values, frequency resources, or a combination thereof.

Utilizing tables 600 and 650 a device may determine an order of bits for a particular transmission. Information for tables 600 and 650 may be determined by devices of the network and/or transmitted throughout the network. As an illustrative, non-limiting example, a base station may determine or set the values of tables 600 and/or 650 and distribute them to UEs of the network. To illustrate, the base station 105 may transmit information for table 600, table 650, or both in the configuration transmission 450 of FIG. 4 and/or the control transmission 452 of FIG. 4. The information for the tables may be sent in the same transmission or in different transmissions. For example, the information for table 650 may be sent in the configuration transmission 450 of FIG. 4 (e.g., RRC transmission) and the information for table 600 may be sent in the control transmission 452 of FIG. 4 (e.g., DCI or PDCCH transmission). To illustrate, the network may indicate bit reliability of a particular bit (or groups of bits as shown in the example of FIG. 6) per MCS via RRC configuration, and indicate the MCS for corresponding channels in a DCI, such as a DCI which schedules or activates one or more transmissions. The UE may then determine an order of bits with the highest reliability for a scheduled frequency band or channel based on the indicated MCS for the frequency resources (from table 600) and on the known bit reliability for the MCS (from table 650).

Referring to FIG. 7, FIG. 7 is a diagram illustrating a table 700 and a table 760 that support enhanced bit level ordering according to one or more aspects. The example of FIG. 7 corresponds to an example of tables for enhanced bit level ordering operations, and specifically for determining an order of bits based on MCS, frequency resources, and bit information. In the example of FIG. 7, the table 700 includes five columns, a first column, a frequency band column 610, and a second column, a MCS column 620. The table 700 indicates a particular MCS to be used with each frequency band or indicates a particular active MCS for each scheduled frequency band.

In the example of FIG. 7, the table 760 includes two columns, a first column, an index column 770, and a second column, subband and bit index column 780. The subband and bit index column 780 may include multiple values or sub columns based on the range of index values in the index column. For example, the index column includes index values having a range of 4, e.g., 0-3, 4-7, and 8-11, and the subband and bit index column includes 4 sub columns or values per index range. The subband and bit index column indicates combinations of subband and bit positions and is determined based on the information of table 700.

The table 760 indicates an order of bits for each index which prioritizes the bit position reliability indicated by table 700. To illustrate, for the index values 0-3, the device uses the highest bit reliability for the first index value of 0 or sub column, i.e., the first and second bit positions in the subband or frequency range of 2 which have a reliability of 0.94. The device then plots the rest of the bit reliability values to corresponding indexes in a descending reliability order. To illustrate, the next highest reliability of 0.92 for frequency band/subband 1 and bit positions 1 and 2 (first and second bits) are mapped to the next or second index value of 1, and this continues on until the lowest reliabilities of 0.6 for frequency and/subband 0 and 3 and bit positions 5 and 6 (fifth and sixth bits) are mapped to the last index values of 10 and 11.

Utilizing tables 700 and 760 a device may determine an order of bits for a particular transmission based on frequency information, MCS information, and bit reliability information. Information for tables 700 and 760 may be determined by devices of the network and/or transmitted throughout the network. As an illustrative, non-limiting example, a base station may determine or set the values of table 700 and distribute them to UEs of the network. To illustrate, the base station 105 may transmit information for table 700 in the configuration transmission 450 of FIG. 4 and/or the control transmission 452 of FIG. 4. The information for the table 700 may be sent in the same transmission or in different transmissions. For example, a portion of the information for table 700 may be sent in the configuration transmission 450 of FIG. 4 (e.g., RRC transmission) and another portion of the information for table 700 may be sent in the control transmission 452 of FIG. 4 (e.g., DCI or PDCCH transmission). To illustrate, the base station may provide the bit reliability information for each combination of subband and MCS in the configuration transmission 450 of FIG. 4 (e.g., RRC transmission), and indicate which MCS and subbands to use for a particular transmission in the in the control transmission 452 of FIG. 4 (e.g., DCI or PDCCH transmission). The UE may then determine the information of table 760 (i.e., an order of bits with the highest reliability) based on the information of table 700 (e.g., a subset of the information provided in the in the configuration transmission 450 of FIG.) for the indicated MCS and subbands (e.g., as indicated in the control transmission 452 of FIG. 4).

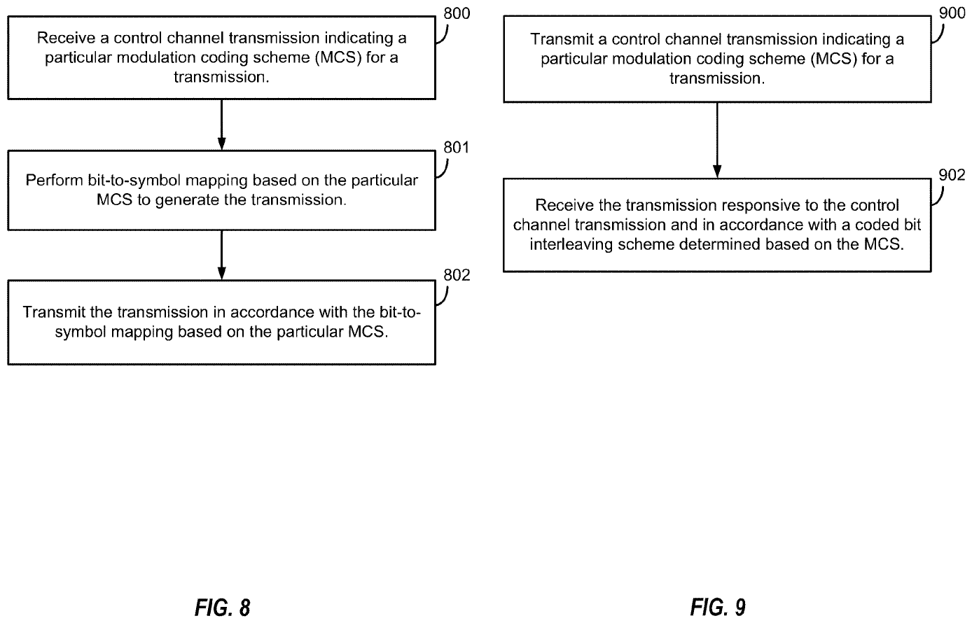

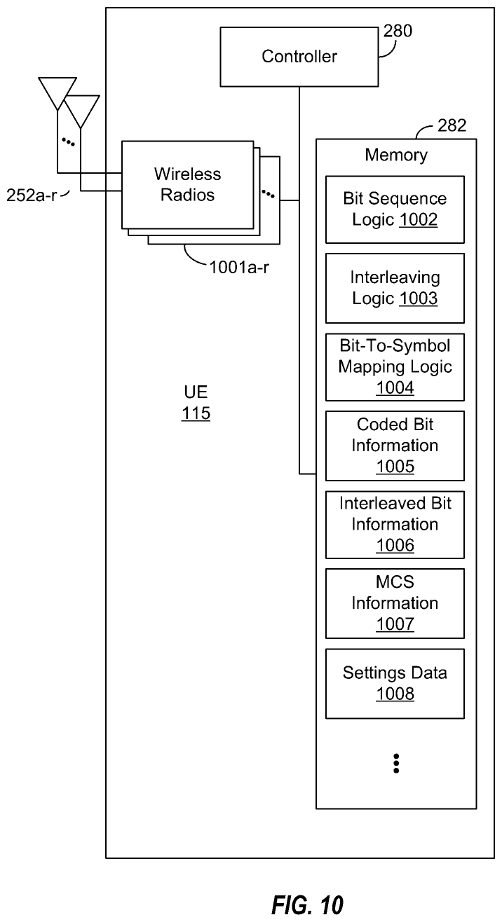

FIG. 8 is a flow diagram illustrating example blocks executed by a wireless communication device (e.g., a UE or base station) configured according to an aspect of the present disclosure. The example blocks will also be described with respect to UE 115 as illustrated in FIG. 10. FIG. 10 is a block diagram illustrating UE 115 configured according to one aspect of the present disclosure. UE 115 includes the structure, hardware, and components as illustrated for UE 115 of FIGS. 2 and/or 4. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1001a-r and antennas 252a-r. Wireless radios 1001a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 10, memory 282 stores bit sequence logic 1002, interleaving logic 1003, bit-to-symbol mapping logic 1004, coded bit information data 1005, interleaved coded bit information data 1006, MCS information data 1007, and settings data 1008. The data (1002-1008) stored in the memory 282 may include or correspond to the data (406, 408, 442, and/or 444) stored in the memory 404 of FIG. 4.

At block 800, a wireless communication device, such as a UE, receives a control channel transmission indicating a particular modulation coding scheme (MCS) for a transmission. The control channel transmission may include or correspond to one or more of the control transmission 452 of FIG. 4 or the second control transmission 456 of FIG. 4, such as a DCI, RRC transmission, or a PDCCH message. The particular MCS may be indicated by MCS information included in the control channel transmission or based on a type of the control channel transmission, such as the type of DCI. The MCS indication may be indicated explicitly/directly or implicitly/indirectly. For example, the UE (e.g., UE 115) may receive a control transmission 452, such as a DCI, from the base station 105 including an MCS indication (such as MCS information 462). To illustrate, UE 115 receives the control transmission 452 via wireless radios 1001a-r and antennas 252a-r and including the MCS information 462 indicating a particular MCS for a transmission scheduled by the control transmission 452 or the second control transmission 456, such as an upcoming PUSCH (such as data transmission 454) or PDSCH (second data transmission 458).

At block 801, the UE performs bit-to-symbol mapping based on the particular MCS to generate the transmission. The bit-to-symbol mapping may correspond to mapping particular bits to respective bit positions, based on a bit ordering scheme or order of bits (also referred to as a modulation order or bit order) associated with the MCS, and mapping the (possibly rearranged) bits to symbols. To illustrate, the interleaver 415 may determine a bit position for each coded bit of the coded bits 406, based on the determined bit ordering scheme, and the interleaver 415 may rearrange (e.g., interleave) the coded bits 406 from a first sequence (e.g., 123654) to a second sequence to generate the interleaved bits 408. The order or sequence of the bits (order of bits) may be referred to as the bit order or the modulation order. The bit-to-symbol mapper 416 may the determine symbols for the interleaved bits 408, such as for the sequence of bits of thereof and as based on the bit value at each bit position. As illustrative examples, the UE (such as the interleaver 415 thereof) may determine the specific order or position of the bits, such as the sequence of the interleaved bits 408, based on the MCS, the MCS and frequency information, the MCS and bit position information, or any combination thereof, as described with reference to FIGS. 5-7. The UE may then rearrange the bits to a specific sequence, such as those illustrated in column 530 of FIG. 5. To clarify, performing bit-to-symbol mapping based on the particular MCS to generate the transmission may include interleaving or generating interleaved coded bits based on a sequence or order of bits which is associated with and determined at least based on the particular MCS, and the performing symbol mapping on the interleaved bits.

At block 802, the UE transmits the transmission in accordance with the bit-to-symbol mapping based on the particular MCS. For example, the UE 115 may modulate the generated or determined symbols, from the bit-to-symbol mapping process, for transmission to another network device, such as base station 105. To illustrate, a transmitter (e.g., transmit processor 264 or transmitter 410) of the UE 115 transmits the data transmission 454 via wireless radios 1001a-r and antennas 252a-r by modulating symbols representing the interleaved bits 408.

The wireless communication device (e.g., UE or base station) may execute additional blocks (or the wireless communication device may be configured further perform additional operations) in other implementations. For example, the wireless communication device (e.g., the UE 115) may perform one or more operations described above, such as described with reference to FIGS. 3A, 3B, and 4-7. As another example, the wireless communication device (e.g., the UE 115) may perform one or more aspects as presented below or as presented in FIGS. 9 and 10.

In a first aspect, the UE 115, such as the at least one processor thereof, configured to perform the bit-to-symbol mapping the at least includes to: interleave coded bits for the transmission based on the particular MCS, and where the transmission is transmitted in accordance with the interleaved coded bits.

In a second aspect, alone or in combination with the first aspect, the UE 115 configured to perform the bit-to-symbol mapping includes to: receive a coded bit sequence (e.g., encoded bit sequence of a code block, d0-d6) for the transmission including coded bits; interleave the coded bits of the coded bit sequence to generate an interleaved coded bit sequence; and map the coded bits of the interleaved coded bit sequence to symbols, where the transmission corresponds to the symbols.

In a third aspect, alone or in combination with one or more of the above aspects, the UE 115 is further configured to: receive an input bit sequence (e.g., encoded bit sequence of a code block, a0-a6); generate code blocks from the input bit sequence (e.g., break the encoded bit sequence into chunks and add parity bits, c1-c6); and encode (e.g., perform channel encoding c to d) the code blocks to generate coded bit sequences, including the coded bit sequence for the transmission.

In a fourth aspect, alone or in combination with one or more of the above aspects, the UE 115 is configured to: determine a coded bit interleaving scheme based on the particular MCS, where the bit-to-symbol mapping is performed based on the determined coded bit interleaving scheme.

In a fifth aspect, alone or in combination with one or more of the above aspects, the UE 115 is configured to: determine a coded bit interleaving scheme based on the particular MCS and on frequency resources, where the bit-to-symbol mapping is performed based on the determined coded bit interleaving scheme.

In a sixth aspect, alone or in combination with one or more of the above aspects, the UE 115 is configured to: determine a bit order (e.g., order of bits) based on the particular MCS and based on frequency resources; and determine a coded bit interleaving scheme based on the determined bit order, where the bit-to-symbol mapping is performed based on the determined coded bit interleaving scheme.

In a seventh aspect, alone or in combination with one or more of the above aspects, the transmission includes data bits and parity bits, and where the data bits are in higher bit order positions than the parity bits. In some such implementations, the transmission may further include CRC bits, which may be may be added after encoding and prior to FEC. Additionally, or alternatively, the data bits may be in higher bit order positions than the CRC bits.

In an eighth aspect, alone or in combination with one or more of the above aspects, the transmission includes data bits and parity bits, and the data bits are in front of the parity bits. In some such implementations, the transmission may further include CRC bits, which may be may be added after encoding and prior to FEC. Additionally, or alternatively, the data bits may be in front of the CRC bits.

In a ninth aspect, alone or in combination with one or more of the above aspects, the UE 115 is configured to: obtain (e.g., receive or retrieve) bit order information (e.g., order of bits) for each MCS, for each FR band, or both; and determine a coded bit interleaving scheme based on the bit order information, where the bit-to-symbol mapping is performed based on the determined coded bit interleaving scheme.

In a tenth aspect, alone or in combination with one or more of the above aspects, the UE 115 is configured to: receive a second control channel transmission indicating a second particular MCS, the second particular MCS different from the particular MCS; and transmit or receive a second transmission with a second coded bit interleaving scheme, where the second coded bit interleaving scheme is different than a first coded bit interleaving scheme of the transmission and associated with the particular MCS, and where the second transmission and the transmission have a same bit order (e.g., same amount of bits).

In an eleventh aspect, alone or in combination with one or more of the above aspects, the UE 115 is configured to: receive a second control channel transmission indicating coded bit interleaving configuration information, the coded bit interleaving configuration information including bit order information (e.g., order of bits) for each MCS, for each FR band, or both, where the bit-to-symbol mapping is performed based on the coded bit interleaving configuration information.

In a twelfth aspect, alone or in combination with one or more of the above aspects, the bit order information includes bit capacity information, bit error rate information, or both.

In a thirteenth aspect, alone or in combination with one or more of the above aspects, the second control channel transmission comprises an RRC transmission and is received prior to the control channel transmission.

In a fourteenth aspect, alone or in combination with one or more of the above aspects, the UE 115 is configured to: receive coded bit interleaving configuration information, the coded bit interleaving configuration information indicating a coded bit interleaving scheme for each MCS, for each FR band, or for each combination of MCS and FR band.

In a fifteenth aspect, alone or in combination with one or more of the above aspects, the coded bit interleaving configuration information is included in the control channel transmission, where the control channel transmission comprises a DCI, and where the transmission comprises a PUSCH.

In a sixteenth aspect, alone or in combination with one or more of the above aspects, where the coded bit interleaving configuration information is included in a second control channel transmission, where the second control channel transmission comprises a RRC transmission received prior to the control channel transmission.

In a seventeenth aspect, alone or in combination with one or more of the above aspects, the bit to symbol mapping uses a non-uniform shaped constellation, such as a geometric shaped constellation.

In an eighteenth aspect, alone or in combination with one or more of the above aspects, the bit to symbol mapping generates a plurality of symbols, and the UE 115 is configured to: modulate symbols of the plurality of symbols according to a modulation scheme (or modulating scheme) indicated by the MCS.

In a nineteenth aspect, alone or in combination with one or more of the above aspects, a device for wireless communication includes: at least one processor; and a memory coupled to the at least one processor, where the at least one processor is configured to: receive a control channel transmission indicating a particular modulation coding scheme (MCS) for a transmission; and receive the transmission responsive to the control transmission and in accordance with a coded bit interleaving scheme determined based on the MCS.

In a twentieth aspect, alone or in combination with one or more of the above aspects, a device for wireless communication, includes: at least one processor; and a memory coupled to the at least one processor, where the at least one processor is configured to: transmit a first transmission in accordance with a first MCS and a first coded bit interleaving sequence; and transmit a second transmission in accordance with a second MCS and a second coded bit interleaving sequence, where the first transmission and the second transmission have the same bit order (e.g., same length of coded bit sequence or amount/number of bits), and where the second coded bit interleaving sequence is different from the first coded bit interleaving sequence, and where the second MCS is different from the first MCS.

In a twenty-first aspect, alone or in combination with one or more of the above aspects, the first coded bit interleaving sequence is in order (e.g., 1-6), and the second coded bit interleaving sequence is not in order (e.g., 123654).

In a twenty-second aspect, alone or in combination with one or more of the above aspects, the at least one processor is configured to: determine the first coded bit interleaving sequence based on the first MCS; and determine the second coded bit interleaving sequence based on the second MCS.

In a twenty-third aspect, alone or in combination with one or more of the above aspects, the at least one processor is configured to: determine the first coded bit interleaving sequence, the second coded bit interleaving sequence, or both, based further on frequency resources of the transmissions, where the frequency resources correspond to a frequency band, a subband, a particular layer, a particular slot, or a combination thereof.

In a twenty-fourth aspect, alone or in combination with one or more of the above aspects, the at least one processor is configured to: determine the first coded bit interleaving sequence, the second coded bit interleaving sequence, or both, based further on bit level capacity for each bit of the coded sequence, where the bit level capacity corresponds to a quality level of information carried by a particular bit or a reliability level of the particular bit.

In a twenty-fifth aspect, alone or in combination with one or more of the above aspects, the bit level capacity is determined on bit error rate (BER), received bit level capacity information per MCS, received bit level capacity information per frequency resource, or a combination thereof.

In a twenty-sixth aspect, alone or in combination with one or more of the above aspects, the at least one processor is configured to: perform forward error correction (FEC) on the first transmission and the second transmission, where the FEC comprises a polar encoding scheme or a low density parity check coding scheme.

Accordingly, wireless communication devices may perform enhanced bit interleaving operations for wireless communication devices. By performing enhanced bit interleaving operations, throughput can be increased and latency and errors can be reduced through the usage of more reliable bits (bit positions) to carry data, such as payload data.

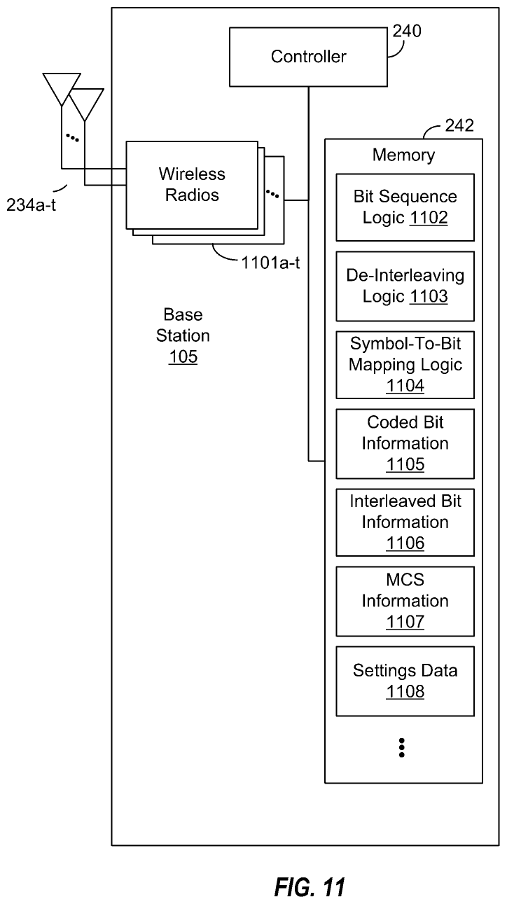

FIG. 9 is a flow diagram illustrating example blocks executed wireless communication device (e.g., a UE or network entity, such as a base station) configured according to an aspect of the present disclosure. The example blocks will also be described with respect to base station 105 as illustrated in FIG. 11. FIG. 11 is a block diagram illustrating base station 105 configured according to one aspect of the present disclosure. Base station 105 includes the structure, hardware, and components as illustrated for base station 105 of FIGS. 2 and/or 4. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1101a-t and antennas 234a-t. Wireless radios 1101a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 11, memory 242 stores bit sequence logic 1102, de-interleaving logic 1103, symbol-to-bit mapping logic 1104, coded bit information data 1105, interleaved coded bit information data 1106, MCS information data 1107, and settings data 1108. The data (1102-1108) stored in the memory 242 may include or correspond to the data (406, 408, 442, and/or 444) stored in the memory 432 of FIG. 4.

At block 900, a wireless communication device, such as a network device (e.g., a base station 105), transmits a control channel transmission indicating a particular modulation coding scheme (MCS) for a transmission. The control channel transmission may include or correspond to one or more of the control transmission 452 of FIG. 4, the DCI with LC IDs at 520 of FIG. 5, or the PDCCH transmissions of FIGS. 6A-10B. For example, the base station 105 may transmit the control transmission 452 or the second control transmission 456 to the UE 115 including MCS information 462 (such as an MCS indication for an upcoming transmission). To illustrate, base station 105 transmits a DCI via wireless radios 1101a-r and antennas 234a-t and including an MCS indication for an upcoming uplink or downlink transmission scheduled by the DCI.

At block 901, the wireless communication device receives the transmission responsive to the control channel transmission and in accordance with a coded bit interleaving scheme determined based on the MCS. The transmission may include or correspond to one or more of the data transmission 454 of FIG. 4 or the second data transmission 458, as described with reference to FIG. 4. For example, the base station 105 receives the data transmission 454 from the UE 115. To illustrate, a receiver (e.g., receive processor 238 or receiver 436) of the base station receives the data transmission 454 via wireless radios 1101a-r and antennas 234a-t which includes or corresponds to modulated symbols representing the interleaved bits 408. The wireless communication device may then process the received modulated symbols based on a de-interleaving scheme identified by the de-interleaver 439, which may be identified as described with refernece to FIGS. 4-8. For example, the symbol-to-bit mapper 440 (symbol demapper) may generate the interleaved bits 408 based on demodulating or demapping the received modulated symbols and then the de-interleaver 439 may de-interleave or reorder the interleaved bits 408 to determine, generate, or recover the coded bits 406.

The wireless communication device (e.g., such as a UE or base station) may execute additional blocks (or the wireless communication device may be configured further perform additional operations) in other implementations. For example, the wireless communication device may perform one or more operations as described with reference to FIGS. 3A, 3B, and 4-7. As another example, the wireless communication device may perform one or more aspects as described above with reference to FIGS. 8 and 10 or one or more aspects as presented below.

In a first aspect, the wireless communication device, such as a base station 105, is further configured to (e.g., the processor is further configured to): perform symbol-to-bit mapping based on the particular MCS to decode symbols of the transmission to generate interleaved coded bits for the transmission.

In a second aspect, alone or in combination with the first aspect, the base station 105 is configured to: determine a coded bit interleaving scheme based on at least the particular MCS; deinterleave the interleaved coded bits for the transmission based on the particular MCS to generate coded bits, wherein the coded bits correspond to the transmission; and process the coded bits of the coded bit sequence for the transmission.

In a third aspect, alone or in combination with one or more of the above aspects, to perform the symbol-to-bit mapping the base station 105 is configured to: demodulate received modulated symbols corresponding to the transmission; and demap the demodulated symbols of the transmission to generate the interleaved coded bits of the interleaved coded bit sequence.

In a fourth aspect, alone or in combination with one or more of the above aspects, the base station 105 is configured to: determine a coded bit interleaving scheme based on the particular MCS, wherein the de-interleaving is performed based on the determined coded bit interleaving scheme.

In a fifth aspect, alone or in combination with one or more of the above aspects, the base station 105 is configured to: determine a coded bit interleaving scheme based on the particular MCS and on frequency resources, wherein the de-interleaving is performed based on the determined coded bit interleaving scheme.

In a sixth aspect, alone or in combination with one or more of the above aspects, the base station 105 is configured to: determine a bit order (e.g., order of bits) based on the particular MCS and based on frequency resources; and determine a coded bit interleaving scheme based on the determined bit order, wherein the de-interleaving is performed based on the determined coded bit interleaving scheme.

In a seventh aspect, alone or in combination with one or more of the above aspects, the base station 105 is configured to: transmit a second control channel transmission indicating a second particular MCS, the second particular MCS different from the particular MCS; and transmit or receive a second transmission with a second coded bit interleaving scheme, wherein the second coded bit interleaving scheme is different than a first coded bit interleaving scheme of the transmission and associated with the particular MCS, and wherein the second transmission and the transmission have a same bit order.

In an eighth aspect, alone or in combination with one or more of the above aspects, the base station 105 is configured to: transmit a second control channel transmission indicating coded bit interleaving configuration information, the coded bit interleaving configuration information including bit order information (e.g., order of bits) for each MCS, for each FR band, or both, wherein the coded bit interleaving scheme is determined based on the coded bit interleaving configuration information.

In a ninth aspect, alone or in combination with one or more of the above aspects, a device for wireless communication includes: at least one processor; and a memory coupled to the at least one processor, where the at least one processor is configured to: transmit a control channel transmission indicating a particular modulation coding scheme (MCS) for a transmission; and perform bit-to-symbol mapping based on the particular MCS to generate the transmission; and transmit the transmission in accordance with the bit-to-symbol mapping based on the particular MCS.

In a tenth aspect, alone or in combination with one or more of the above aspects, a device for wireless communication, includes: at least one processor; and a memory coupled to the at least one processor, where the at least one processor is configured to: receive a first transmission in accordance with a first MCS and a first coded bit interleaving sequence; and receive a second transmission in accordance with a second MCS and a second coded bit interleaving sequence, where the first transmission and the second transmission have the same bit order (e.g., same length of coded bit sequence or amount/number of bits), and where the second coded bit interleaving sequence is different from the first coded bit interleaving sequence, and where the second MCS is different from the first MCS.

In an eleventh, alone or in combination with one or more of the above aspects, the first coded bit interleaving sequence is in order (e.g., 1-6), and the second coded bit interleaving sequence is not in order (e.g., 123654).

In a twelfth aspect, alone or in combination with one or more of the above aspects, the at least one processor is configured to: determine the first coded bit interleaving sequence based on the first MCS; and determine the second coded bit interleaving sequence based on the second MCS.

In a thirteenth aspect, alone or in combination with one or more of the above aspects, the at least one processor is configured to: determine the first coded bit interleaving sequence, the second coded bit interleaving sequence, or both, based further on frequency resources of the transmissions, where the frequency resources correspond to a frequency band, a subband, a particular layer, a particular slot, or a combination thereof.

In a fourteenth aspect, alone or in combination with one or more of the above aspects, the at least one processor is configured to: determine the first coded bit interleaving sequence, the second coded bit interleaving sequence, or both, based further on bit level capacity for each bit of the coded sequence, where the bit level capacity corresponds to a quality level of information carried by a particular bit or a reliability level of the particular bit.

In a fifteenth aspect, alone or in combination with one or more of the above aspects, the bit level capacity is determined on bit error rate (BER), received bit level capacity information per MCS, received bit level capacity information per frequency resource, or a combination thereof.

In a sixteenth aspect, alone or in combination with one or more of the above aspects, the at least one processor is configured to: perform forward error correction (FEC) on the first transmission and the second transmission, where the FEC comprises a polar encoding scheme or a low density parity check coding scheme.

Accordingly, wireless communication devices may perform enhanced bit interleaving operations for wireless communication devices. By performing enhanced bit interleaving operations, throughput can be increased and latency and errors can be reduced through the usage of more reliable bits (bit positions) to carry data, such as payload data.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-11 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A wireless communication device, comprising:
one or more processors; and
one or more memories coupled with the one or more processors and storing processor-executable code that, when executed by the one or more processors, is configured to cause the wireless communication device to:
receive a control channel transmission indicating a particular modulation coding scheme (MCS) for a transmission;
perform bit-to-symbol mapping based on the particular MCS to generate the transmission; and
transmit the transmission in accordance with the bit-to-symbol mapping based on the particular MCS.

2. The wireless communication device of claim 1, wherein to perform the bit-to-symbol mapping the one or more processors are configured to cause the device to:
interleave coded bits for the transmission based on the particular MCS, and wherein the transmission is transmitted in accordance with the interleaved coded bits.

3. The wireless communication device of claim 1, wherein to perform the bit-to-symbol mapping the one or more processors are configured to cause the wireless communication device to:
receive a coded bit sequence for the transmission including coded bits;
interleave the coded bits of the coded bit sequence to generate an interleaved coded bit sequence; and
map the coded bits of the interleaved coded bit sequence to symbols, wherein the transmission corresponds to the symbols.

4. The wireless communication device of claim 3, wherein the one or more processors are configured to cause the wireless communication device to:
receive an input bit sequence;
generate code blocks from the input bit sequence; and
encode the code blocks to generate coded bit sequences, including the coded bit sequence for the transmission.

5. The wireless communication device of claim 1, wherein the one or more processors are configured to cause the wireless communication device to:
determine a coded bit interleaving scheme based on the particular MCS, wherein the bit-to-symbol mapping is performed based on the determined coded bit interleaving scheme.

6. The wireless communication device of claim 1, wherein the one or more processors are configured to cause the wireless communication device to:
determine a coded bit interleaving scheme based on the particular MCS and on frequency resources, wherein the bit-to-symbol mapping is performed based on the determined coded bit interleaving scheme.

7. The wireless communication device of claim 1, wherein the one or more processors are configured to cause the wireless communication device to:
determine a bit order based on the particular MCS and based on frequency resources; and
determine a coded bit interleaving scheme based on the determined bit order, wherein the bit-to-symbol mapping is performed based on the determined coded bit interleaving scheme.

8. The wireless communication device of claim 1, wherein the transmission includes data bits and parity bits, and wherein the data bits are in higher bit order positions than the parity bits.

9. The wireless communication device of claim 1, wherein the transmission includes data bits and parity bits, wherein the data bits are in front of the parity bits.

10. The wireless communication device of claim 1, wherein the one or more processors are configured to cause the wireless communication device to:
obtain bit order information for each MCS, for each FR band, or both; and
determine a coded bit interleaving scheme based on the bit order information, wherein the bit-to-symbol mapping is performed based on the determined coded bit interleaving scheme.

11. The wireless communication device of claim 1, wherein the one or more processors are configured to cause the wireless communication device to:
receive a second control channel transmission indicating a second particular MCS, the second particular MCS different from the particular MCS; and
transmit or receive a second transmission with a second coded bit interleaving scheme, wherein the second coded bit interleaving scheme is different than a first coded bit interleaving scheme of the transmission and associated with the particular MCS, and wherein the second transmission and the transmission have a same bit order.

12. The wireless communication device of claim 1, wherein the one or more processors are configured to cause the wireless communication device to:
receive a second control channel transmission indicating coded bit interleaving configuration information, the coded bit interleaving configuration information including bit order information for each MCS, for each FR band, or both, wherein the bit-to-symbol mapping is performed based on the coded bit interleaving configuration information.

13. The wireless communication device of claim 12, wherein the bit order information includes bit capacity information, bit error rate information, or both.

14. The wireless communication device of claim 12, wherein the second control channel transmission comprises an RRC transmission and is received prior to the control channel transmission.

15. The wireless communication device of claim 1, wherein the one or more processors are configured to cause the wireless communication device to:
receive coded bit interleaving configuration information, the coded bit interleaving configuration information indicating a coded bit interleaving scheme for each MCS, for each FR band, or for each combination of MCS and FR band.

16. The wireless communication device of claim 15, wherein the coded bit interleaving configuration information is included in the control channel transmission, wherein the control channel transmission comprises a DCI, and wherein the transmission comprises a PUSCH.

17. The wireless communication device of claim 15, wherein the coded bit interleaving configuration information is included in a second control channel transmission, wherein the second control channel transmission comprises a RRC transmission received prior to the control channel transmission.

18. The wireless communication device of claim 1, wherein the bit to symbol mapping uses a geometric shaped constellation.

19. The wireless communication device of claim 1, wherein the bit to symbol mapping generates a plurality of symbols, and wherein the one or more processors configured to cause the wireless communication device to transmit the transmission includes to:
modulate symbols of the plurality of symbols according to a modulation scheme indicated by the MCS.

20. A wireless communication device, comprising:
one or more processors; and
one or more memories coupled with the one or more processors and storing processor-executable code that, when executed by the one or more processors, is configured to cause the wireless communication device to:
transmit a control channel transmission indicating a particular modulation coding scheme (MCS) for a transmission; and
receive the transmission responsive to the control channel transmission and in accordance with a coded bit interleaving scheme determined based on the MCS.

21-30. (canceled)
